(19) United States
(12) Patent Application Publication
(10) Pub. No.: US 2008/0033792 A1
(43) Pub. Date: Feb. 7, 2008

(54) Computer and internet-based performance assessment questionnaire and method of candidate assessment

(76) Inventors: Phillip Ernest Rosner, Marietta, GA (US); Jack Leonard Edwards, Toronto (CA)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/888,716

(22) Filed: Aug. 2, 2007

Related U.S. Application Data
(60) Provisional application No. 60/834,839, filed on Aug. 2, 2006.

(51) Int. Cl. G06F 11/34

(52) U.S. Cl. 705/11

(57) ABSTRACT

A computer and/or Internet-based performance assessment and method for candidate assessment, wherein a candidate evaluator utilizes Internet-based, network, or desktop applications to present custom weighted performance assessment questions to candidates, wherein the weighted questions are derived from responses of selected top performers thus enabling a candidate evaluator to evaluate, profile, predict and/or record a potential candidate's performance assessment profile via comparison of the candidate's response with the response of the top performers to predict whether the candidate is likely to be a top performer.

### PRIORITY CLAIM TO RELATED US APPLICATIONS

To the full extent permitted by law, the present United States Non-Provisional patent application claims priority to and the benefit of United States Provisional patent application entitled “Rosner-Edwards Protocol (REP),” filed on Aug. 2, 2006, having assigned Ser. No. 60/834,839 and is incorporated herein in its entirety.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates generally to candidate assessment programs and more specifically to a candidate computer and Internet-based interactive assessment software, questionnaire and method of candidate assessment. The present invention is particularly useful for, although not limited to, assisting companies in the hiring and retention of effective and efficient employees.

### BACKGROUND OF THE INVENTION

An employee-hiring process may characteristically involve substantial devotion of company time and money. Cost for such processes can run into the hundreds of thousands of dollars, or even millions, making a fruitless interview and/or hiring experience a regretful and expensive affair. For instance, taking into account basic hiring expenses, such as employee orientation, legal fees, compliance, employee relations, and employment liability, the typical annual human resource cost per employee can easily exceed $50,000 for a medium to large company.

Expenses accrue even in fruitful employee searches. For example, if a company is bombarded with hundreds of candidate applications for an advertised position, the company's human resources division may undergo an extensive weeding-out process to select applicants who they anticipate will provide the requisite or desired level of skill and/or aptitude for the position. Unfortunately, however, after expenditure of much time and money conducting personal interviews with such potential candidates, many employers may either leave empty-handed or hire individuals who they later discover to possess unacceptable inadequacies and/or incompetence. Moreover, in addition to the time and money wasted in the hiring process, an ineffectual employee may directly and/or indirectly cause a company to lose money, such as through salary, benefits, advertising, employee training, overtime, down-time, lost revenue, possible legal fees, and/or various lost opportunities.

Attracting qualified employees typically entails promoting the company name and/or sending out notification of the company's intent to hire to otherwise uninformed potential employees. As such, searching for promising employee candidates often requires recruiters to travel extensively to job-fair sites, such as college campuses, and to engage in hiring and interviewing processes that are otherwise preferably conducted in-house and on a more formal level. Moreover, although teeming with potential recruits, most job-fairs are inefficient and not conducive to in-depth individual assessment, thus usurping from the recruiter the ability to effectively screen and/or test prospective employees.

As such, a company's successful selection and retention of competent and efficient staff is usually directly proportional to its internal processes for screening individual candidate's skill, experience, work ethics and various other personality traits classified as traits necessary for success in performing an identified position. Unsurprisingly, hiring a workforce comprised of skilled and proficient employees is often an expensive and time-consuming process, often involving announcement and broadcast of available positions, pre-screening of a multitude of candidates, phone interviews, in-person evaluation requiring much planning, and hiring personnel deliberation.

In 1949, psychologist Raymond Cattell began the field of personality testing by publishing his sixteen personality factors (16 PF). Cattell hypothesized that individuals describe themselves and each other according to sixteen different, independent factors. His idea was to describe personality traits and find questions that would detect those traits. Cattell went on to construct the 16 PF Personality Questionnaire, which remains in use today by businesses for employee selection.

Personality testing, and associated methods for evaluating a candidate's personality traits, quickly gained support in the field of employee selection, becoming a common component of hiring processes. Using a theoretical model of a “best performer”, organizational psychologists developed lists of preferred traits for each position within a business organization. Personality tests were developed to measure each of these traits and determine “how close” a candidate came to the “best performer,” or an ideal candidate. During the interview process, candidates are tested using standardized questions developed to determine whether a candidate possessed the desired personality traits determined essential for a specified position. Moreover, organizational psychologists have been tasked with developing processes for selecting candidates for an identified job category, which should filter out poor or bottom performers for a company, and reduce the acquisition cost associated with finding qualified candidates.

However, such standardized personality tests and/or questionnaires have proven to be exclusive. Specifically, if one looks at all top performers in a job category, the top performers may not all be identical with respect to their personality traits. While patterns certainly emerge, strict adherence to a single personality profile (a list of personality traits and their numerical score for each trait) would obviously reject potential top performers who may not exactly match established or selected personality traits for the job category. In addition, standardized personality tests and/or questionnaires focus on a single constellation of personality traits, and again, such tests may be exclusive, for example when the personality traits of different top performers are comprised of extremely different traits and/or styles. For example, the personality traits necessary or beneficial for success as a salesperson in New England (i.e. dealing with “New Englanders”) may likely not be the same as those traits necessary or beneficial for success as a salesperson in the Deep South (i.e. dealing with “Southerners”).

Another inherent problem with a static set of standardized personality test questions is that organizations, and their products, customers, competitors, and the like, evolve over time. Therefore, the standardized questions developed to determine whether a candidate possesses desired personality traits may become outdated, and ineffectual. For example, a newly introduced product may support a high price, and high profit margins, due to little or no competition. Over time, however, such products may become commoditized, or price sensitive, as competition appears. While this product cycle may take several years, the personality traits necessary to achieve product sales in the beginning may likely change or evolve as the product cycle matures. Indeed, it seems tenuous to believe that the personality traits of top performing sales people will remain the same over these cycles.

Still further, the procedure associated with developing a personality trait test is extremely complex. Because a test must be valid, actually measuring what it purports to measure, and reliable, consistent in its ability to measure, the process of test development is arduous and expensive. Therefore, new versions of tests are typically not obtained since changing even one question would require a repeat of the entire validation process. The process may include selection of the personality traits, and number of traits, to test. Then questions are selected, evaluated, and revised to ensure that the test, as a whole, meets the criteria for validity. Once the questions are complete, they are “fixed”, and remain unchanging until a new version of the test is developed. The greater the number of personality traits selected, the more complicated and expensive the test construction and interpretation becomes. This process of developing questions that accurately and reliably measure a personality trait requires a large amount of time and expense, such that creating a new version is typically cost prohibitive, potentially involving a complete duplication of the time and expense of the previous version.

Therefore, it is readily apparent that there is a need for a performance assessment test, and a method of candidate assessment, that enables dynamic performance evaluation to continuously improve candidate selection and to continuously adapt to changing conditions without the cost of remaking the test, whereby the need for time-consuming and costly face-to-face interviews may be reduced and conventional recruitment processes may be streamlined.

### BRIEF SUMMARY OF THE INVENTION

Briefly described, in a preferred embodiment, the present invention overcomes the above-mentioned disadvantages, and meets the recognized need for such a device by providing a computer and/or Internet-based performance assessment questionnaire and method for candidate assessment, wherein a candidate evaluator utilizes Internet-based, network or desktop applications to present custom-weighted performance assessment test questions to candidates, wherein the weighted questions are derived from responses from current top performers, requiring candidate response, thus enabling a candidate evaluator to evaluate, profile and record a potential candidate's performance assessment profile in relation to top performers based on the responses tendered and predict whether a candidate is likely to be a top performer.

According to its major aspects and broadly stated, the present invention in its preferred form is a computer and/or Internet-based performance assessment questionnaire and method thereof comprising, in general, a central server system connected to a database storage device that utilizes a computer program adapted to present candidates with a series of custom-weighted performance assessment questions requiring responses thereto, wherein the responses submitted by the candidate enable an evaluator to more efficiently select one or more candidate possessing a desired performance profile, such as that of a top performer, and wherein performance data on one or more selected candidate and/or other top performer is periodically utilized to update or adjust the weight associated with each performance assessment question, and to quickly and easily selectively provide candidate assessment, to the evaluator.

Thus, application of the present invention is designed to reduce the burden and expense associated with developing a customized subset of performance assessment questions or questionnaire, based on identifying questions effective in predicting for task specific performance success, and enable individual candidate assessment and prediction of top performing candidates.

More specifically, the present invention is a computer and/or Internet-based performance assessment program, wherein the program is installed on a local computer or is installed on a remote computer and accessed via a network or Internet-based system. The candidate assessment program is rendered accessible by a candidate through entry of preselected information, such as through utilization of a log-in password, that may be input via a local interactive graphical interface or an on-line interactive menu. After accessing the candidate assessment program, such as by logging in, the candidate may be presented with a series of questions designed to elicit responses for subsequent evaluation. Based on a comparison of the response provided by the candidate with one or more response provided previously by one or more top performers, and/or one or more responses provided previously by one or more bottom performer, an evaluator may accurately evaluate the candidate's performance trait strengths and weaknesses in relation to previously queried top performers and/or bottom performers, predict a particular candidate's future performance, and select a candidate based thereon, thereby greatly reducing lost time and/or money associated with selection of a candidate who is unfit or incompetent, and thereby reducing the importance or frequency of conducting a personal interview.

A feature and advantage of the present invention is its ability to identify one or more top performers from a pool of candidates by comparing a candidate's responses to a subset of performance assessment questions derived from a master set of performance assessment questions, wherein the selected subset of questions are selected based on their ability to differentiate between top performers and bottom performers.

Another feature and advantage of the present invention is its ability to identify a subset of questions that differentiate between top performers and bottom performers of a validation group in relation to actual success or failure at the selected activity or skill via querying a group of current actual top performers and/or current actual bottom performers, referred to collectively as the validation group. Such identification is accomplished by utilizing a master set of performance assessment questions to solicit responses from each member of the validation group, and by assigning a weight to each question based on the degree to which the question differentiates between the top performers and the bottom performers, or based on the degree to which the question identifies a top performer or a bottom performer.

Another feature and advantage of the present invention is its ability to differentiate between top performers and bottom performers of a group in relation to actual success or failure at the selected activity or skill utilizing any set of personality trait questions provided such questions solicit a response.

Another feature and advantage of the present invention is its ability to differentiate between top performers and bottom performers of a group in relation to actual success or failure at the selected activity or skill without determining a personality profile of a candidate or person under evaluation or a personality profile numerical score of a candidate or person under evaluation.

Another feature and advantage of the present invention is its ability to quickly select a custom subset of questions from the master list of performance assessment questions that differentiate between top performers and bottom performers by creating a weighting profile for each question and response based on responses tendered by members of the validation group, the validation group consisting of current top performers and/or current bottom performers.

Another feature and advantage of the present invention is its ability to provide a server-based artificial intelligence engine capable of evaluating and weighting responses tendered by members of the validation group, creating a weighting profile, and updating the weighting profile based on subsequent performance data of the validation group members and/or selected candidates to continuously or periodically adjust performance prediction capabilities.

Another feature and advantage of the present invention is its ability to periodically update the weighting profile for each question, response, and combinations of connections therebetween of the subset of questions from the master list of performance assessment questions by inputting current performance data from the validation group.

Another feature and advantage of the present invention is its ability of the designated artificial intelligence engine assigned to a particular query to evolve, wherein such artificial intelligence engine is capable of continuously or periodically updating a weighting profile based on subsequent performance data from the current performers.

Another feature and advantage of the present invention is its ability to predict top performance without revising the master set of performance assessment questions and without developing custom questions based on specific performance traits under investigation by repeated use of a standard master set of questions.

Another feature and advantage of the present invention is its ability to derive a selected subset of performance assessment questions having a weighted profile from a normative group comprised of an actual performer population.

Another feature and advantage of the present invention is its ability to derive a subset of performance assessment questions having a weighted profile, which may immediately be used in candidate selection, thereby providing an evaluator with immediate candidate feedback.

Another feature and advantage of the present invention is its ability to dynamically update the weighted profile of the subset of performance assessment questions utilizing subsequent performance data of candidates selected based, at least in part, on the systems evaluation thereof, or performance prediction therefor.

Another feature and advantage of the present invention is its ability to identify one or more candidates as likely top performers based on any selected measurable performance data, including performance data collected as a matter of course or collected to monitor or assess performance.

Another feature and advantage of the present invention is its ability to accurately and consistently identify performance patterns from one or more top performer of a selected task even though two or more top performers may have different or varying personality traits.

Another feature and advantage of the present invention is its ability to develop a plurality of questionnaires to identify performance patterns of top performers, wherein such performance patterns are specific to a category, or subset, of the top performers, such as categories or subsets based on geography, product-type, product life cycle, other market factors, or the like.

Another feature and advantage of the present invention is its ability to reduce the need for face-to-face interviews, conventional candidate review processes and/or other forms of personal interviews, thus saving the time and money.

Another feature and advantage of the present invention is its ability to be used as an Internet-based application, thus enabling evaluation of geographically disparate candidates without extensive travel by avoiding the necessity of face-to-face interviews or other forms of personal interviews with bottom performing candidates, whereby the candidate assessment results are substantially instantaneous.

Another feature and advantage of the present invention is its ability to be installed and run from any local computer or accessed via the Internet, thus enabling a candidate evaluation from any geographic location.

Another feature and advantage of the present invention is its ability to be used as an in-house assessment program for development, reassessment, and objective planning.

Another feature and advantage of the present invention is its ability to enable an evaluator to process more candidates in a given amount of time than accomplished through personal interviews, thereby reducing a cost associated with such processing, and/or enabling processing of a greater number of candidates for a given cost.

Another feature and advantage of the present invention is its ability to automatically track and record candidate demographics, including, but not limited to, residency, demographic information, experience level, educational level, previous experience, desired salary, or the like.

Another feature and advantage of the present invention is its ability to automatically track and record Affirmative Action data and other pertinent legal documentation.

Another feature and advantage of the present invention is its ability to automatically track and record candidate responses/demographics that were considered in the evaluation of the candidate.

Another feature and advantage of the present invention is its ability to provide a future reference source of performance traits considered in the selection or non-selection of the candidate.

Another feature and advantage of the present invention is its ease of use and operation.

Another feature and advantage of the present invention is its ability to be designed to meet the performance data criteria and standards particular to each evaluator (the party requesting the candidate evaluation).

Another feature and advantage of the present invention is its ability to incorporate the use of streaming computer or on-line video simulations of performance scenarios accompanied by related interactive questions, responses to which may be used to assess a candidate's likely performance.

Another feature and advantage of the present invention is its ability to reduce evaluators cost and time from that generally associated with an extensive candidate review process.

Another feature and advantage of the present invention is its ability to be run on platforms such as, but not limited to, MICROSOFT, SQL, and ORACLE.

Another feature and advantage of the present invention is its ability to have cross platform capabilities.

Another feature and advantage of the present invention is its ability to be coupled with live telephone interviews and/or candidate querying, wherein the results of the telephone interview questions and responses can be entered into the program database.

Another feature and advantage of the present invention is its ability to create evaluation questions for virtually any field of endeavor from the same master set of questions and methodology.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a block diagram of a computer system of the present invention;

FIG. 2 is a block diagram of a communications system implemented by the computer system in FIG. 1;

FIG. 3 is a flow diagram of a process, according to the preferred embodiment of the present invention, implemented via the communications system in FIG. 2;

FIG. 4 is a screen shot exemplar of a user interface of the process of FIG. 3;

FIG. 5 is a screen shot of a graphical user interface provided by the Internet-based interactive performance assessment according to a preferred embodiment of the present invention showing the landing page presented on a computer screen to a user of the process of FIG. 3;

FIG. 6 is a screen shot of a graphical user interface provided by the Internet-based interactive performance assessment according to a preferred embodiment of the present invention showing the introduction to the performance assessment presented on a computer screen to a user of the process of FIG. 3;

FIG. 7 is a screen shot of a graphical user interface provided by the Internet-based interactive performance assessment according to a preferred embodiment of the present invention showing the instructions for the performance assessment presented on a computer screen to a user of the process of FIG. 3;

FIG. 8 is a screen shot of a graphical user interface provided by the Internet-based interactive performance assessment according to a preferred embodiment of the present invention showing question 1 of 500 for the performance assessment presented on a computer screen to a user of the process of FIG. 3;

FIG. 9 is a screen shot of a graphical user interface provided by the Internet-based interactive performance assessment according to a preferred embodiment of the present invention showing question 2 of 500 for the performance assessment presented on a computer screen to a user of the process of FIG. 3; and

FIG. 10 is a screen shot of a graphical user interface provided by the Internet-based interactive performance assessment according to a preferred embodiment of the present invention showing assessment complete for the performance assessment presented on a computer screen to a user of the process of FIG. 3.

### DETAILED DESCRIPTION OF THE PREFERRED AND ALTERNATIVE EMBODIMENTS

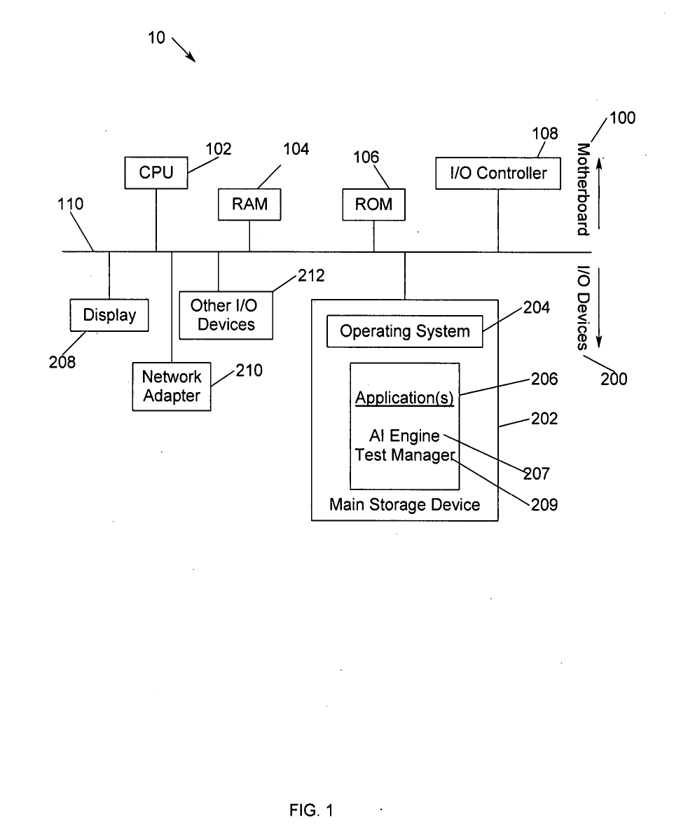

In describing the preferred and alternate embodiments of the present invention, as illustrated in FIGS. 1-10, specific terminology is employed for the sake of clarity. The invention, however, is not intended to be limited to the specific terminology so selected, and it is to be understood that each specific element includes all technical equivalents that operate in a similar manner to accomplish similar functions.

As will be appreciated by one of ordinary skill in the art, the present invention may be embodied as a method, data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program code means embodied in the medium. Any suitable computer readable medium may be utilized including hard disks, ROM, RAM, CD-ROMs, electrical, optical or magnetic storage devices.

The present invention is described below with reference to flowchart illustrations of methods, apparatus (systems), and computer program products according to embodiments of the present invention. It will be understood that each block or step of such flowchart illustrations, and combinations of blocks or steps in the flowchart illustrations, may be implemented by computer program instructions. These computer program instructions may be loaded onto a general-purpose computer, special-purpose computer, or other programmable data processing apparatus to produce a machine, such that instructions, which execute on the computer or other programmable data processing apparatus, create means for implementing the functions specified in the flowchart block or blocks/step or steps.

These computer program instructions may also be stored in a computer-usable memory that can direct a computer or other programmable data processing apparatus to function in a particular manner, such that the instructions stored in the computer-usable memory produce an article of manufacture including instruction means which implement the function specified in the flowchart block or blocks/step or steps. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks/step or steps.

Accordingly, blocks or steps of the flowchart illustrations support combinations of means for performing the specified functions, combinations of steps for performing the specified functions and program instruction means for performing the specified functions. It should also be understood that each block or step of the flowchart illustrations, and combinations of blocks or steps in the flowchart illustrations, may be implemented by special purpose hardware-based computer systems, which perform the specified functions or steps, or combinations of special purpose hardware and computer instructions.

Computer programming for implementing the present invention may be written in various programming languages, such as, conventional C calling, or database languages such as Oracle or .NET. However, it is understood that other source or object oriented programming languages, and other conventional programming language may be utilized without departing from the spirit and intent of the present invention.

Referring now to FIGS. 1-10, the present invention in its preferred embodiment is a computer and/or Internet-based performance assessment questionnaire and method for candidate assessment thereof 300, preferably comprising a graphical interface 208 capable of displaying templates 400, 500, 600, 700, 800, 900, and 1000 thereon, wherein performance assessment questionnaire and method for candidate assessment 300 is installed, configured, accessed and utilized via a local computer or accessed and utilized as a global networking system application. Furthermore, although templates 400, 500, 600, 700, 800, 900, and 1000 are the preferred graphical images used to define a performance assessment questionnaire and method for candidate assessment 300, templates 400, 500, 600, 700, 800, 900, and 1000 are exemplary of a variety of different templates or graphical images that may be used to define performance assessment questionnaire and method for candidate assessment.

For brevity, several elements in the figures described below are represented as monolithic entities. However, as will be understood by one ordinarily skilled in the art, these elements each may include numerous connected computers and/or components designed to perform one or more specified operation and/or dedicated to a particular task.

Referring now more particularly to FIG. 1, there is illustrated a block diagram of computer system 10 that provides a suitable environment for implementing embodiments of the present invention. The computer architecture shown in FIG. 1 is divided into two parts, namely, motherboard 100 and input/output (I/O) devices 200. Motherboard 100 preferably includes subsystems such as central processing unit (CPU) 102, random access memory (RAM) 104, input/output (I/O) controller 108, and read-only memory (ROM) 106, also known as firmware, which are operable via bus 110. A basic input output system (BIOS) containing basic routines that may help to transfer information between elements (components) within the subsystems of the computer is preferably stored in ROM 106, or operably disposed in RAM 104. Computer system 10 further preferably includes I/O devices 200, such as main storage device 202 for storing an operating system 204, application program(s) 206, and display 208 for visual output, respectively. Main storage device 202 is preferably connected to CPU 102 through a main storage controller (represented as 108) connected to bus 110. Network adapter 210 allows the computer system to send and receive data through communication devices. One example of a communications device is a modem, including cable and digital subscriber line (DSL), cellular, satellite, or other similar modems. Other examples include a transceiver, a set-top box, a communication card, a satellite dish, an antenna, or any other network adapter capable of transmitting and receiving data over a communications link that is either a wired, optical, or wireless data pathway.

Many other devices or subsystems 212 may be connected in a similar manner, including but not limited to, devices such as microphone, speakers, sound card, keyboard, pointing device (e.g., a mouse), floppy disk, CD-ROM player, DVD player, printer and/or modem each connected via an I/O adapter. Also, although preferred, it is not necessary for all of the devices shown in FIG. 1 to be present to practice the present invention, as discussed below. Furthermore, the devices and subsystems may be interconnected in different configurations from that shown in FIG. 1, or may be based on optical or biological processors or gate arrays, or some combination of these elements that is capable of responding to and executing instructions. The operation of a computer system such as that shown in FIG. 1 is readily known in the art and is not discussed in further detail in this application, so as not to unnecessarily complicate the present discussion.

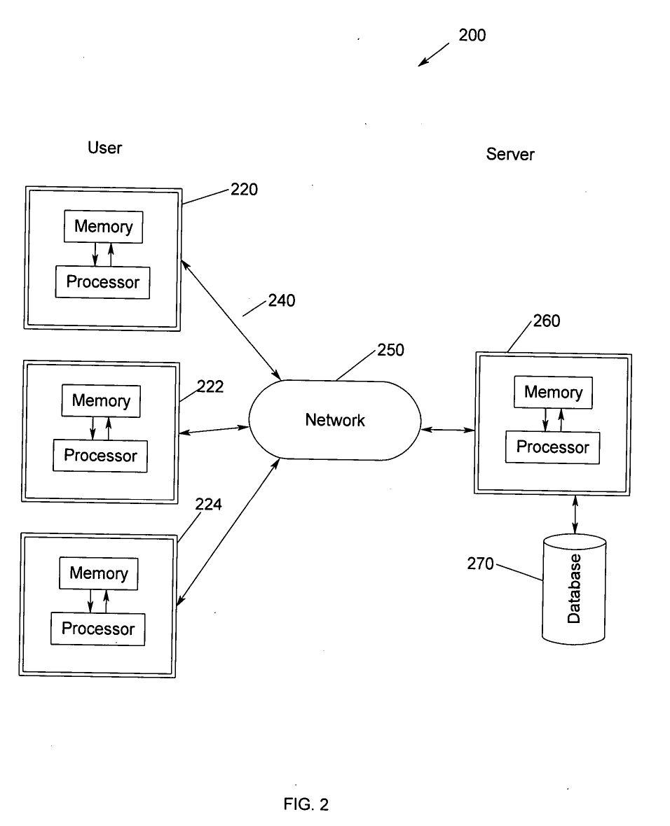

Referring now to FIG. 2, there is illustrated a diagram depicting an exemplary system in which concepts consistent with the present invention may be implemented. Examples of each element within the communication system of FIG. 2 are broadly described above with respect to FIG. 1. In particular, the server system 260 and user system 220 have attributes similar to computer system 10 of FIG. 1 and illustrate one possible implementation thereof. Communication system 200 preferably includes one or more user systems 220, one or more server device 260, and network 250, which could be, for example, the Internet. User systems 220 each preferably include a computer-readable medium, such as random access memory, coupled to a processor. The processor executes program instructions stored in the memory. User system 220 may also include a number of additional external or internal devices, such as, without limitation, a mouse, a CD-ROM, a keyboard, a display, a storage device and other attributes similar to computer system 10 of FIG. 1. Communications system 200 typically includes one or more user system 220. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a component, other equipment, or some combination of these elements that is capable of responding to and executing instructions.

Similar to user system 220, server system 260 preferably includes a computer-readable medium, such as random access memory (RAM), coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1. Server system 260 may additionally include a secondary storage element, such as database 270 for storage of applications, data and information. Server system 260, although depicted as a single computer system, may be implemented as a network of computer processors. Memory in server system 260 contains one or more application program(s) 206 (shown in FIG. 1) For example, the server system 260 may include one or more general-purpose computers (e.g., personal computers), one or more special purpose computers (e.g., devices specifically programmed to communicate with each other) a workstation or other equipment, or some combination of these elements that is capable of responding to and executing instructions.

Communications system 200 is capable of delivering and exchanging data between user system 220 and a server system 260 through communications link 240 and/or network 250. Through user system 220, users can preferably communicate over network 250 with each other and with other systems and devices coupled to network 250, such as server system 260. Communications link 240 typically includes a delivery network 250 making a direct or indirect communication between the user system 220 and the server system 260, irrespective of physical separation. Examples of a network 250 include the Internet, the World Wide Web, WANs, LANs, analog or digital wired and wireless telephone networks (e.g. PSTN, ISDN, or XDSL), radio, wireless, television, cable, satellite, and/or any other delivery mechanism for carrying and/or transmitting data or other information. The communications link 240 may include, for example, a wired, wireless, cable, optical or satellite communication system or pathway.

Application program 206 (shown in FIG. 1) preferably includes an artificial intelligence engine 207, which preferably enables server system 260 to i) process and analyze responses to questions from a master list of performance assessment questions tendered by one or more validation group members, comprising current top performers and/or current bottom performers and/or process and analyze responses to a subset of performance assessment questions by one or more candidate, operating user system 220; ii) identify and produce a custom subset of questions from the master list of performance assessment questions that best differentiates between top performers and bottom performers, and creating a weighting profile for each question, response, and/or combinations of connections therebetween based on responses tendered by the validation group members; and iii) process and analyze responses tendered by one or more candidate in response to the subset of custom weighted performance assessment questions via operating user system 222 to determine whether responses tendered by a particular candidate are those corresponding to a top performer or bottom performer as compared to the responses tendered by the validation group member.

Application program 206 (shown in FIG. 1) preferably includes query manager 209, which enables server system 260 to communicate with an evaluator such as via user system 220 to i) organize and manage querying of the validation group members such as via user system 222 to initiate querying of current top performers and/or current bottom performers utilizing the master list of performance assessment questions; ii) organize and manage querying of one or more selected candidate such as via user system 220 and to initiate querying of selected candidates utilizing the subset of custom-weighted performance assessment questions and iii) immediately enable an employer, or other person or entity requesting the assessment, to review candidate response to questions and/or a summary report indicating or explaining whether, or to what degree, responses tendered by the candidate correspond to those of one or more top performer and/or bottom performer via comparison to the validation group members responses.

Communications system 200 preferably enables users to communicate questions, response choices, and chosen responses via user system 220, user system 222, and server system 260, and to share information related to candidate evaluation. Further, communications system 200 preferably provides users of user system 220, 222, 224 a registration template with fill-in the blank and user selected criteria for identifying the user and linking validation group member 222 to the evaluator's master set of performance assessment questions and linking candidate 224 to a subset of the master set of performance assessment questions.

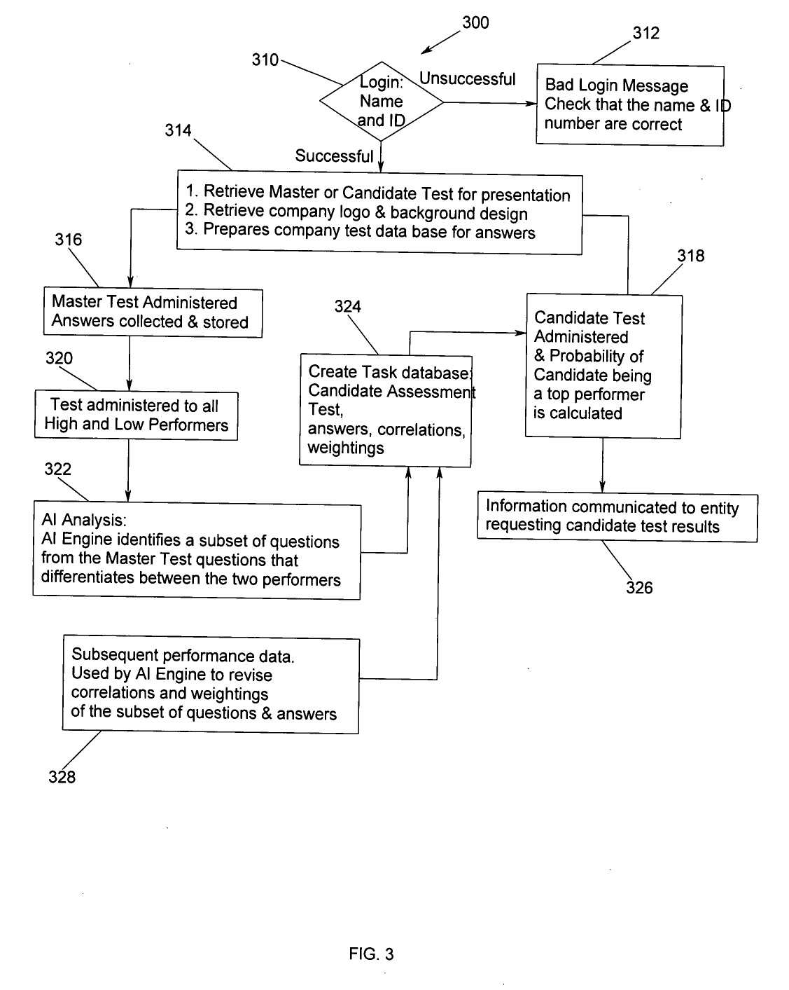

Referring now to FIG. 3, there is illustrated a preferred flow diagram in which user 220, user 222, user 224, and server system 260 interact according to performance assessment questionnaire and method for candidate assessment 300 within communication system 200 of FIG. 2. Performance assessment questionnaire and method for candidate assessment 300 preferably may be implemented by communication system 200 or other similar hardware, software, device, computer, computer system, equipment, component, application, code, storage medium, or propagated signal.

Referring then to FIGS. 3-10, each of templates 400, 500, 600, 700, 800, 900 and 1000 preferably comprise information relating to performance assessment questionnaire and method for candidate assessment 300, wherein such information preferably includes one or more of instructional information, questions, response choices or other information/instructions particular to the content of the assessment program and embodied in performance assessment questionnaire and method for candidate assessment 300. Each of templates 400, 500, 600, 700, 800, 900 and 1000 further preferably includes user-selectable mechanisms that enable the user to exit, terminate, pause and/or commence performance assessment questionnaire and method for candidate assessment 300. Furthermore, each of templates 400, 500, 600, 700, 800, 900 and 1000 preferably include user-selectable mechanisms that enable the user to advance to subsequent templates or return to previously viewed templates.

Specifically, each of templates 800, 900 and 1000 preferably display a series of questions and a series of response choices, wherein a user may select a response choice or enter a free-form response to a question, within its respective response field. Each of templates 800 through 1000 may further comprise an advance button 810, a previous button 808, wherein advance button is preferably labeled “Next” and preferably allows the user to advance to the next question; return button is preferably labeled “Previous” and preferably allows the user to return or go back to any of previously viewed questions at any desired time. Upon completing one or more questions on any one of templates 800, 900 and 1100, a user may click or activate advance button 810 to advance to successive templates to answer one or more question displayed thereon.

Furthermore, application program 206 (shown in FIG. 1) preferably includes a query manager 209, which enables server system 260 to communicate with evaluator 220, validation group member 222, or candidate 224 via user system 220/222/224 to i) organize and manage querying of validation group member 222 and to initiate querying of current top performers and/or bottom performers utilizing the master list of performance assessment questions; ii) organize and manage the querying of one or more selected candidate as candidate 224 and to initiate querying of candidate 224 utilizing the subset of custom-weighted performance assessment questions; and iii) enable immediate review of candidate 224 responses and/or summary report explaining whether, or to what degree responses tendered candidate 224 correspond to those of a top performer or a bottom perform as compared to responses provided by validation group members.

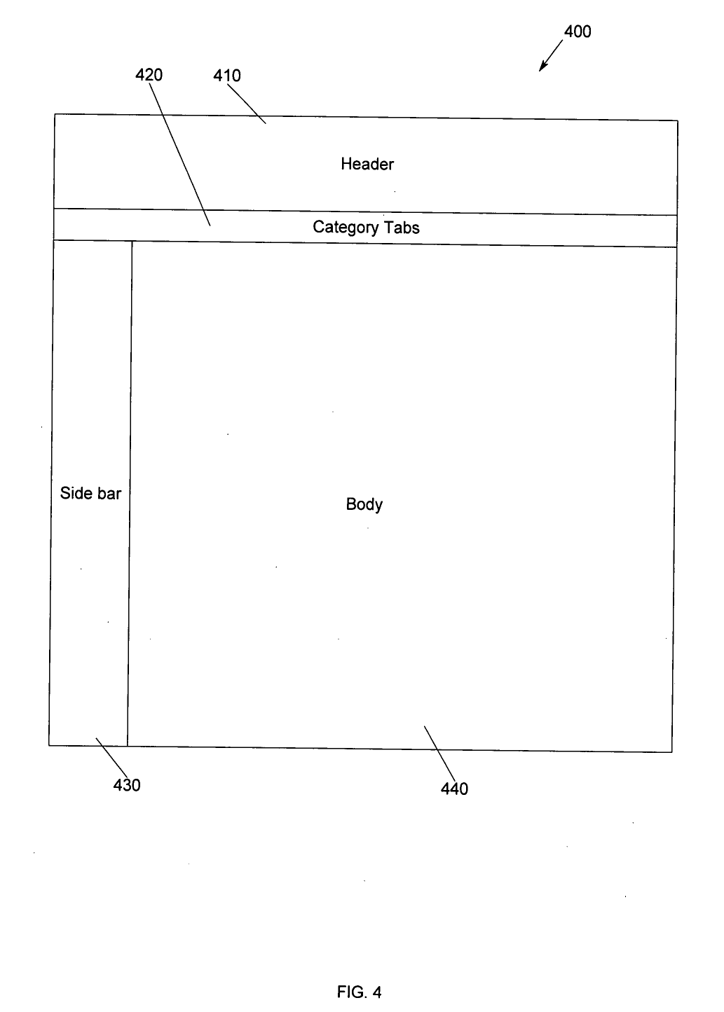

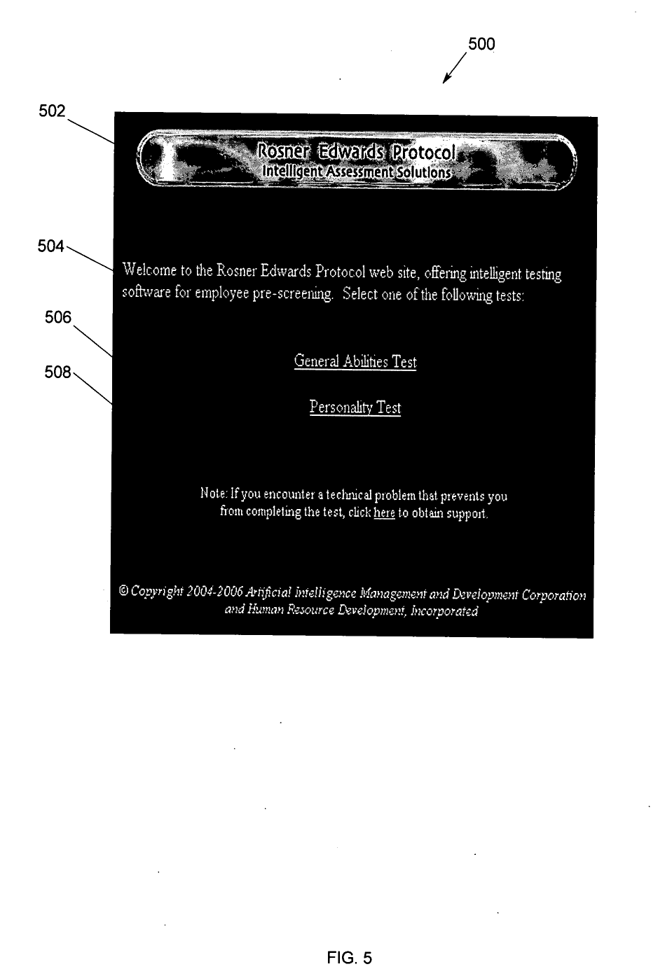

As illustrated in FIG. 3, preferred process 300 starts with step 310, wherein users 220/222/224 enters a website domain name or address into an Internet browser or other application, preferably website shown in FIG. 5 and wherein, in response server system 260, associated with such website domain name or website, preferably instructs user system 220 to display at least one instruction or template 400 (see FIG. 4) whereby user 220/222/224 may enter a user name and/or password (or other identification) to login into server system 260 of communication system 200 and gain access to application program 206. Upon server system 260 receiving user's 220/222/224 identification server system 260 may check such identification against users 220 login record stored in database 270. If server system 260 finds a match between user's 220 submitted name and password and user 220 records as either validation group member 222 or candidate 224 in database 270, users 220 is granted access to application program 206. However, if user 220 is not registered with server system 260 as validation group member 222 or candidate 224, user 220 preferably is sent a message “no record found for this user” or the like and thereafter user 220 must enroll, to become a user and/or create a user profile with server system 260 to gain access to application program 206 (step 312).

Accordingly, in step 312, server system 260 preferably generates and sends user 220/222/224, or otherwise causes display of, at least one instruction or template 400 (see FIG. 4) for user 220/222/224 to use to guide user 220/222/224 through a procedure for generating a login record. Template 400, such as a sign-up template, is preferably a graphical user interface generated by server system 260 and communicated to user 220/222/224 having at least one field or window that enables user 220/222/224 to enter text and/or data in predefined fields, such as drop down window, thereby allowing user 220/222/224 to select from a set of predefined options, or radial button(s), such that upon clicking or activating such button, user 220/222/224 has selected a predefined option, or button(s) enabling user 220/222/224 to make a selection. User 220/222/224 preferably enters text and/or data into sign-up template 400 populating the fields of sign-up template 400 with user information or other information requested by server system 260. More specifically, user 220/222/224 selects a unique user name and password, and server system 260 preferably prompts user 220/222/224 to provide additional user 220/222/224 profile information such as name, title, company, address, mail stop, telephone number, email address, department, position, position number and the like (“user information”) to be stored by server system 260 as a record of user 220/222/224 in database 270.

User 220/222/224 preferably clicks or activates on a send button of template 400 sending user information to server system 260. Server system 260 receives user 220/222/224 information and stores same in database 270. Sign-up template 400, (and other templates discussed hereinbelow, as well) are preferably generated using a common internet language such as HTML or XML. “Common internet language” as used herein means a computer programming language that is a standard or common programming language designed to facilitate communication between the different types of computers and operating systems found on the Internet, and specifically includes all versions of Java, HTML (hypertext markup language) and XML (extensible markup language) or any other webpage development language.

Referring to FIG. 4, template 400 (and other templates discussed hereinbelow, as well) is preferably a general user interface (GUI) computer screen such as a website page(s) or the like having text, graphics, text entry regions, drop down selection regions, radial selection buttons, clickable or activating buttons and the like. Any combination of the above features, along with other common website page features may be utilized to perform substantially the same purposes as illustrated herein. The preferred illustrated text and graphics of template 400 is exemplary of the preferred content of process 300. Moreover, template 400 preferably can be personalize or customized with text, graphics, pictures, audio files, video files and the like. Still further, template 400 can be designed to display any information, instruction, graphic and/or text deemed relevant to the employer, person or entity requesting the assessment. GUIs and website pages are readily known in the art and are not discussed in further detail in this application, so as not to unnecessarily complicate the present discussion. Moreover, website and GUI pages are stored in database 270 and are delivered to user 220 via server system 260 and network 250. Template 400 preferably includes but is not limited to header 410, category tabs 420, side bar 430, and body 440 which organize the page into regions having text, graphics, text entry regions, tabs, hyper-links, drop-down selection regions, radial buttons, clickable or activating buttons, audio, video, and the like. Any suitable format may be utilized for expression or collection of the information and/or data.

Next, in step 314, of process 300, pursuant to information input into sign-up template 400, server system 260 receives the instruction that user 220/222/224 has requested to become a user and thereafter, server system 260 preferably determines from user's 220/222/224 record of user information stored in database 270 whether user 220/222/224 is a validation group member 222 or a candidate 224. Such designation, whether a particular user 220/222/224 is a validation group member 222 or a candidate 224 is preset by the person or entity requesting the evaluation of users 222/224. Upon server system 260 identifying user 222/224, server system 260 preferably sends user 222/224 a revised template(s) 400 having text, graphics, and the like identifying the person or entity requesting the evaluation of user 222/224. Furthermore, template(s) 400 preferably comprise introductory and/or instructional information, including but not limited to, text, graphics, text entry regions, tabs, hyper links, drop-down selection regions, radial buttons, clickable or activating buttons, audio, video and a user 222/224 selectable means for initiating the querying and/or assessment procedure, such as, by user 222/224 activating a button, which sends a response to server system 260 requesting the initiation of the querying or assessment procedure.

Referring to FIG. 5, template 500 a screen shot of a graphical user interface, wherein template 500 preferably includes, but is not limited to title 502, welcome statement 504, and hyper links 506 and 508. Template 500 preferably comprises an overview and welcome to the website text. The preferred illustrated text, set forth in welcome statement 504, is exemplary of the preferred content of introductory instructional welcome statement 504. However, alternate text and/or words and/or images may be utilized to convey to user 222/224 the intended message and/or information. Furthermore, template 500 preferably enables user 222/224 to select between two employee pre-screening options entitled “General Abilities Testing” 506 and “Personality Testing” (performance assessment querying) 508. General Abilities Testing (performance assessment querying) 506 preferably assesses a user's 222/224 ability to solve a set of verbal, math, and logic problems in an attempt to measure intelligence as a predictor of performance and/or ability. Alternatively, Personality Testing 508 preferably assesses aspects of user's 222/224 character as a predictor of performance and/or ability. Preferably, and also at step 314, user 220/224 activates one of hyper-link 506 and hyper-link 508 sending a signal to server system 260 requesting an associated questionnaire and/or assessment as a predictor of performance and/or ability. Next, in step 314, upon server system 260 receiving the signal, server system 260 retrieves the associated questionnaire and/or assessment selected by user 222/224. If user 222/224 is determined to be a validation group member 222, server system 260 preferably retrieves the master set of questions from database 270 and administers the master questionnaire for validation group member 222 (step 316). If user 222/224 is determined to be a candidate 224, server system 260 preferably retrieves the subset of custom-weighted performance assessment questions from database 270 and administers the subset questionnaire for candidate 224 (step 318).

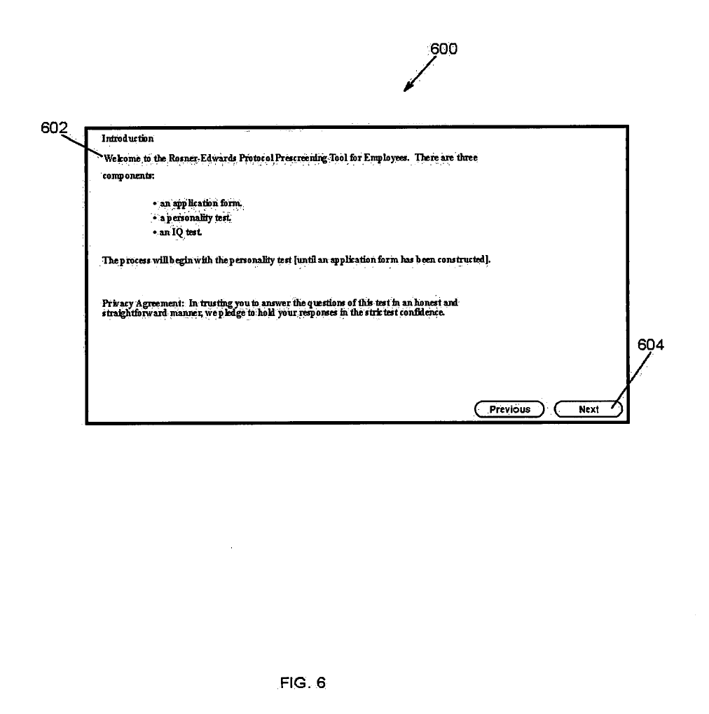

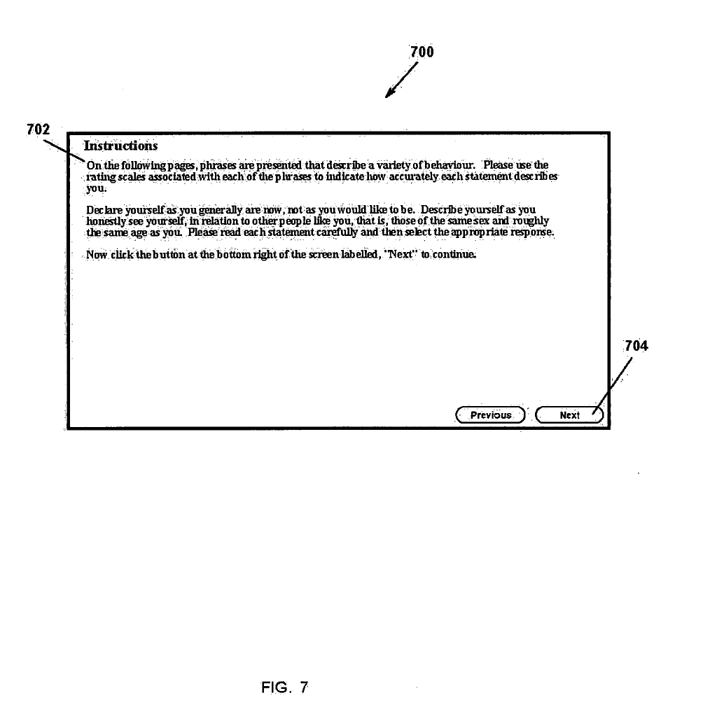

Preferably next, in step 314, of process 300 and referring now to FIG. 6, template 600 a screen shot of a graphical user interface, wherein template 600 preferably displays text 602 introducing validation group member 222 to the Personality Testing 508 and upon validation group member 222 reading the introduction and activating button 604 “Next”, process 300 preferably proceeds to display template 700 a screen shot of a graphical user interface shown in FIG. 7, wherein template 700 preferably displays text for instructions on how to analyze and respond to each question set forth in Personality Testing 508 and upon validation group member 222 reading the instructions and activating button 704 “Next”, process 300 preferably proceeds to step 316.

Preferably next, in step 316, each validation group member 222 is preferably presented with five hundred (500) selected performance assessment questions comprising the master questionnaire. Server system 260 preferably retrieves each question sequentially 1 through 500, presents them to validation group member 222 and requests validation group member 222 to submit an response for each question by selecting one of the five responses choices “Very Accurate”, “Somewhat Accurate”, “Neither Accurate Nor Inaccurate”, Somewhat Inaccurate”, or “Very Inaccurate.”

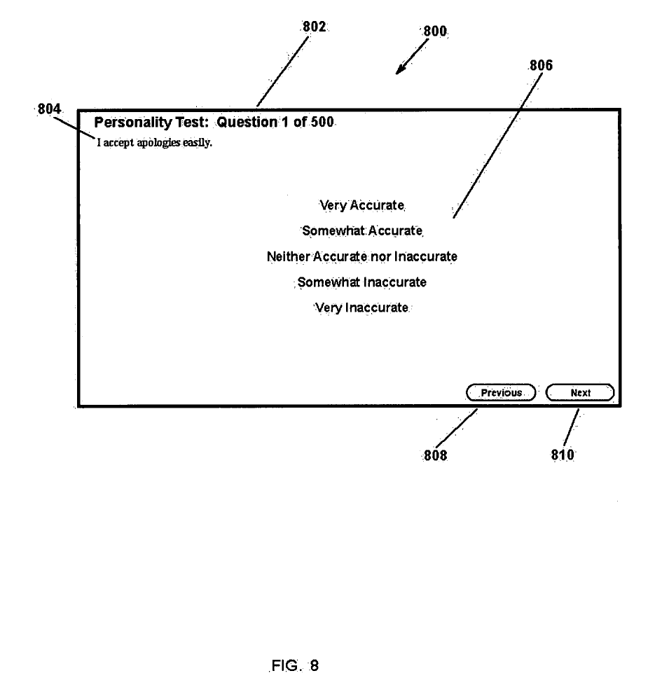

Referring to FIG. 8, template 800 a screen shot of a graphical user interface, wherein template 800 preferably includes, but is not limited to question number 802, performance assessment question 804, responses choices 806, activatable button 808 entitled “Previous” and activatable button 810 entitled “Next”. However, template 800 may have text, graphics and the like, and any arrangement conducive to the effective communication the questions or other intended information to validation group member 222. In operation validation group member 222 reviews question 804, selects a response from response choices 806 based on the instructions set forth in FIG. 7, selects and indicates the selected response of responses choices 806, and activates button 810 entitled “Next”, whereby validation group member 222 is presented with the next question. Upon validation group member 222 activating button 810 entitled “Next”, server system 260 receives a signal corresponding to the selected response for question 804 via network 250 and stores data corresponding to the selected response in database 270 along with data corresponding to the selected responses to all other questions 1-500 for validation group member 222.

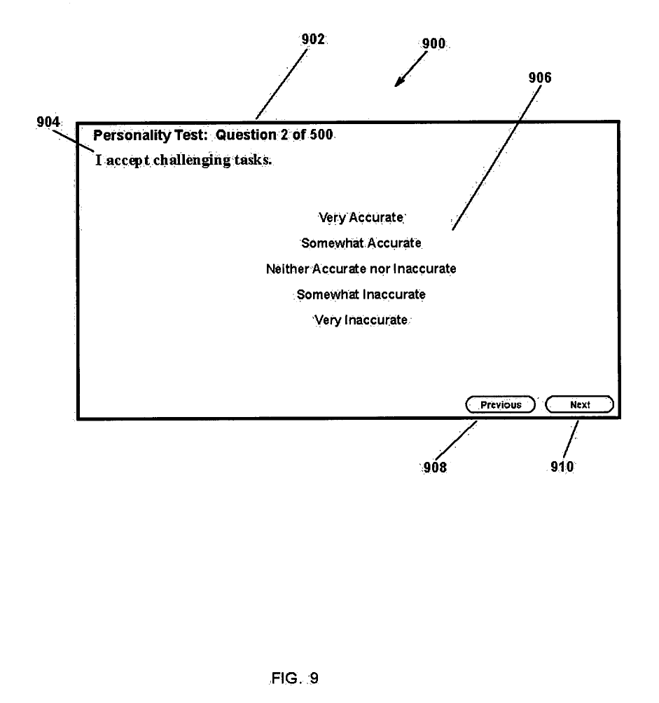

Referring to FIG. 9, template 900 a screen shot of a graphical user interface, wherein template 900 preferably includes, but is not limited to question number 902, performance assessment question 904, responses choice 906 (in this example same as responses choice 806), activatable button 908 entitled “Previous” and activatable button 910 entitled “Next”. As with template 800, template 900 may have text, graphics and the like, and any arrangement conducive to the effective communication the questions or other intended information to validation group member 222. In operation, validation group member 222 reviews question 904 selects a response from response choices 906 based on the instructions set forth in FIG. 7, selects and indicates the selected response of responses choices 906, and activates button 910 entitled “Next”, whereby validation group member 222 is presented with the next in series question, and so on for all 500 questions. If validation group member 222 desires to return to a previous question such as question 804, validation group member 222 may activate button 908 entitled “Previous”, wherein server system 260 retrieves question 804 and re-transmits question 804 to validation group member 222 enabling validation group member 222 to revise his/her response to question 804. Upon validation group member 222 activating button 910 entitled “Next” server system 260 receives a signal corresponding to the selected response for question 904 via network 250 and stores data corresponding to the selected response in database 270 along with data corresponding to the selected responses to all other questions 1-500 for validation group member 222.

Although the content and form of questions 804/904 are limitless, the above FIGS. 8 and 9 are paradigms of the preferred form and content of questions 804/904.

Preferably, and also in step 316, upon validation group member 222 completing all five hundred (500) selected performance assessment questions comprising the master questionnaire, server system 260 sends validation group member 222 a notice of his/her completion of all five hundred (500) master performance assessment questions.

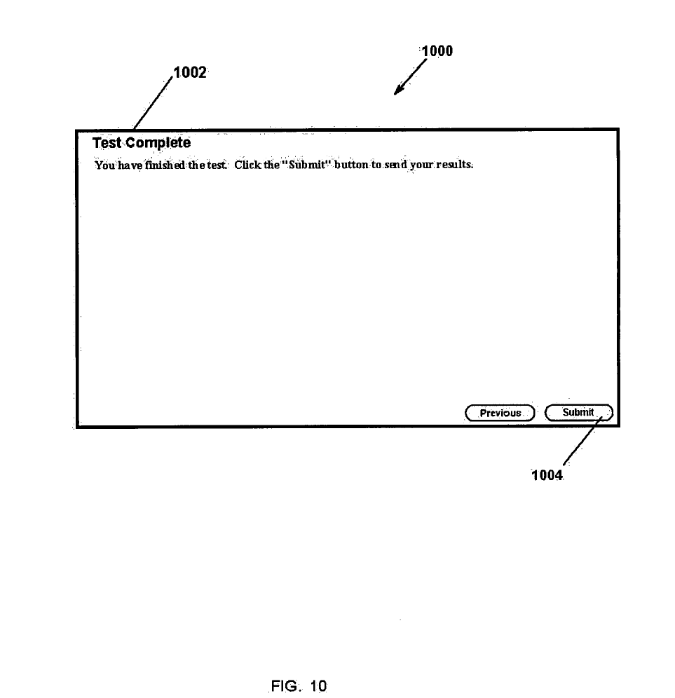

Referring to FIG. 10, template 1000 a screen shot of a graphical user interface, wherein template 1000 preferably displays text 1002 notifying validation group member 222 of his/her completion of Personality Testing 508. Upon validation group member 222 activating button 1004 entitled “Submit” validation group member 222 sends a signal to server system 260 indicating one or more selected responses via network 250 and server system 260 stores data corresponding to the selected response in database 270 along with data corresponding to the responses to all other questions 1-500 for validation group member 222. Moreover, template 1000 preferably displays instructional information that informs the user that the program has come to an end or other information/instructions particular to the status and/or content of the assessment program embodied performance assessment questionnaire and method for candidate assessment 300. Template 1000 further preferably includes user-selectable mechanisms that enable the user to exit, terminate, pause or commence template 1000. Moreover, template 1000 preferably includes user-selectable mechanisms that enable the user to return to previously viewed templates.

Procedure

Performance assessment questionnaire and method for candidate assessment 300 is designed to be utilized as an aid to evaluating a candidate's future performance by building a method for candidate assessment based on prior and updated performance data of individuals currently performing the task under evaluation. The method for candidate assessment 300 divides any group of individual who are currently performing and divides them into high and low performers based on the performance criteria relevant to the task being performed or as set by the individual or entity requesting evaluation of the group. Although the method for candidate assessment 300 consist of performance assessment questions, each assessment is generated based upon actual performance data, not upon personality theory, or predetermined constellations of personality traits. Therefore, each resultant method for candidate assessment 300 is unique to the individuals currently performing the task and of this group which individuals are designated as high performers and which individuals are designated are low performers.

The employer, person or entity requesting the assessment provides information and/or data, which divides the validation group into top performers and bottom performers. Such information and/or data is limitless, the following are paradigms of the preferred information and/or data:

A company selects two groups of normative test takers, determined by their performance on a dimension relevant to the client organization (e.g.—the 40 most successful salesmen and the 40 least successful salesmen). The target situation is sales personnel and performance is based on successful sales of a product or service. If a validation group consisted of 80 sales personnel the sales commission earner or number of products/services sold during a given period of time may be utilized to divide the group into top performers and bottom performers, wherein each validation group member 222 is identified as either a top performer (40 sales people) and bottom performer (the remaining 40 sales people) prior to the administration of performance assessment querying. The purpose of this performance assessment may be to predict top performing sales personnel candidates applying for sales positions. Each sales person known as validation group member 222 is administered the five hundred (500) performance assessment questions comprising the master questions. Server system 260 receives validation group member 222 responses and stores the responses in database 270 along with the responses to all other questions 1-500 for validation group member 222 and similarly for each of the 80 sales personnel.

In addition, multiple subsets of performance assessment sales personnel querying may be developed. For example, a geographic specific performance assessment may be developed for sales personnel operating in different geographical areas or regions, such as northeast and southeast provided there exists performance information or data on the subset sales group, which can be used to differentiate between top performers and bottom performers in the target situation or task being performed.

As another example, a university selects two groups of normative test takers, determined by their performance on a dimension relevant to the university (e.g.—the 20 most successful students and the 80 least successful students). The target situation is college applicants and performance is based on GPA. If a validation group consisted of 100 students and the GPA earner during a given period of time may be utilized to divide the group into top performers and bottom performers, wherein each validation group member 222 is identified as either a top performer (20 students) and bottom performer (the remaining 80 students) prior to the administration of performance assessment querying. The purpose of this performance assessment may be to predict top performing student candidates applying for admission to the university. Each student known as validation group member 222 is administered the five hundred (500) performance assessment questions comprising the master questions. Server system 260 receives validation group member 222 responses and stores the responses in database 270 along with the responses to all other questions 1-500 for validation group member 222 and similarly for each of the 100 students.

In addition, multiple subsets of performance assessment university department specific querying may be developed. For example, a psychology department performance assessment may be developed for students enrolled in the psychology department provided there exists performance information or data on the subset group (psychology department), which can be used to differentiate between top performers and bottom performers.

Because the performance assessment questionnaire and method for candidate assessment 300 is performance-based, not trait-based, such method can be used as a tool to make an inclusion/exclusion decision for any group, or situation in which multiple candidates are being considered. The only requirement is that there exists performance information or data, which can be used to differentiate between top performers and bottom performers in the target situation or task being performed.

Source of Questions

Personality trait questions and performance assessment question making up all five hundred (500) a set of performance assessment questions and responses can be found in the public domain resources, journals, text books to develop and continually refine a set of personality trait questions, responses and various criterion indices, whose items are in the public domain, and can be used for both scientific and commercial purposes. However, questions 804/904 and responses 806/906 and the remaining questions and responses making up all five hundred (500) of the selected performance assessment questions and responses of performance assessment test and method for candidate assessment 300 may be or have been modified, varied, fine tuned or evolved to arrive at an optimum set of questions and responses to differentiate between top performers and bottom performers in the target situation or task being performed.

Preferably, in step 320, each validation group member including top performers and bottom performers are administered master questionnaire performance assessment 300 each individually as a validation group member 222 and server system 260 receives from each validation group member's 222 its selected responses to response choices and stores the data corresponding toe the selected responses in database 270 along with the data corresponding to selected responses to all other questions 1-500 for all validation group member 222 for analysis by method 300.

AI Engine

Application program 206 (shown in FIG. 1) preferably includes an artificial intelligence engine (AI Engine) 207, which preferably enables server system 260 to i) process and analyze responses tendered by validation group member 222 and/or candidate 224; ii) identify and produce a custom subset of questions from the master questionnaire that best differentiate between top performers and bottom performers of validation group members 224 by creating a weighting profile for each question, response, and combinations of connections therebetween based on responses tendered by validation group members 222 of top performers and bottom performers (AI Engine 207 selects a subset of questions that weight most heavily toward selecting top performers. i.e., questions that are the strongest predictors); and iii) process and analyze responses tendered from candidate 224 for subset of custom weighted performance assessment questions to determine whether responses tendered by candidate 224 are those of a top performer or bottom performer as compared to the responses tendered by validation group members 222.

AI Engine 207 preferably is a multi-layer perceptron neural network, however, other known neural networks or later developed are contemplated herein. AI Engine 207 takes as inputs the questions and responses for each user and outputs a model performance prediction.

Following completion of the validation group member 222 performance assessment utilizing the master questionnaire, and also preferably in step 322, AI Engine 207 comprised of a set of evolutionary refinement algorithms (ERAs) analyzes correlations between validation group members 222 responses 806/906 to the questions 804/904 for all five hundred (500) questions of the master questionnaire stored in database 270 and for all validation group members 222. Thereafter, AI Engine 207 identifies a subset of custom-weighted performance assessment questions, preferably 80-100 questions (candidate assessment), from the master questionnaire (five hundred (500) performance assessment questions administered to the validation group members 222), which differentiate to the best degree between top performers and bottom performers in the target situation or task being performed by validation group members 222.

It is contemplated herein that any number of master performance assessment questions may be administered to the validation group members 222 provided such number of questions differentiate to the best degree between top performers and bottom performers.

In addition, it is contemplated herein that any number of subset of custom-weighted performance assessment questions may be administered to the candidate 224 provided such number of questions differentiate to the best degree between top performers and bottom performers.

Preferably next in step 324, following AI Engine's 207 analysis, correlation, and creation of candidate assessment questions under Personality Testing 508, server system 260 stores the subset of custom-weighted performance assessment questions, responses, top performer correlations and weightings for each question, response and validation group members 222 in database 270, wherein server system 260 preferably administers querying of candidate 224.

Candidate Assessment

Next in step 318, preferably candidate 224 enters a website domain name into an Internet browser, gaining access to such website as set forth above (see FIG. 5) and thereafter enters user identification to login into server system 260 of communication system 200 and gain access to application program 206. Upon server system 260 receiving candidate's 224 identification server system 260 checks such information against users 220 login record stored in database 270. If server system 260 finds a match between candidate 224 submitted name and password and user 220 records as candidate 224 is granted access to application program 206. However, if user 220 is not registered with server system 260 as candidate 224, user 220 preferably is sent a message “no record found for this user” or the like and thereafter user 220 must enroll, to become a user and/or create a user profile with server system 260 to gain access to application program 206 (step 312). Preferably next in step 318, server system 260 sends candidate 224 template 500 (referring back to FIG. 5), a screen shot of a graphical user interface, wherein template 500 preferably comprises an overview and welcome to the website text as set forth above.

Preferably next, in step 318, server system 260 sends candidate 224 display template 700 a screen shot of a graphical user interface shown in FIG. 7, wherein template 700 preferably displays text for instructions on how to analyze and respond to each question set forth in Personality Testing 508 and upon candidate 224 reading the instructions and clicking or activating button 704 “Next”, process 300 preferably retrieves the subset of custom weighted performance assessment questions from database 270 and administers the taking of the subset master set of questions for candidate 224.

Preferably next, in step 318, each candidate 224 is preferably presented with the candidate assessment questionnaire. Server system 260 preferably retrieves each question sequentially from the candidate assessment questions, presents each to candidate 224 (as set forth above in templates 800 and 900 shown in FIGS. 8 and 9) and requests candidate 224 to submit an response for each question by selecting one of the five responses choices “Very Accurate”, “Somewhat Accurate”, “Neither Accurate Nor Inaccurate”, Somewhat Inaccurate”, or “Very Inaccurate.”

Preferably next, in step 318, server system 260 receives candidate's 224 signal corresponding to the selected responses for each candidate assessment question via network 250 and stores data corresponding to the selected response in database 270 along with the data corresponding to responses to all other candidate assessment questions for candidate 224.

Preferably next, in step 318, upon candidate 224 completing all candidate assessment questions of candidate assessment questionnaire, server system 260 sends candidate 224 a notice of his/her completion of all candidate assessment questions (as set forth above in template 1000 shown in FIG. 10) notifying candidate 224 of his/her completion of Personality Testing 508.

AI Engine Analysis of Candidate

Following completion of the candidate assessment questionnaire by candidate 224, and also preferably next in step 318, AI Engine 207 analyzes candidate's 224 responses to each candidate assessment question and compares such response to the responses given by the top performers of validation group members 222 and based on the correlation between the responses provided by top performer validation group member 222 and candidate 224 to the same question, AI Engine 207 determines whether candidate 224 is a top performer similar to top performers in validation group member 222 based on the responses selected during candidate assessment querying. Moreover, AI Engine 207 preferably analyzes and determines how many matching responses exist between candidate's 224 responses and top performers of the validation group member's 222 responses for each candidate assessment question, such as responses 806/906 to the questions 804/904, and based on the correlation and weighting AI Engine 207 applies to each question, response, and top performer of validation group member's 222 such engine determines a predicted performance figure and/or a probability of success percentile of candidate 224 becoming a top performer in the target situation or task being performed by validation group member 222.

Preferably next, in step 326 server system 260 communicates probability of success percentile of candidate 224 becoming a top performer in the target situation or task being performed by validation group member 222 to the employer, person or entity requesting the assessment of candidate 224, including but not limited to, candidate 224 responses, probability of success percentile, and a summary report explaining whether responses tendered by candidate 224 are those of a top performer as compared to responses tendered by validation group member 222. The employer, person or entity requesting the assessment of candidate 224 utilizes the information provided by performance assessment questionnaire and method for candidate assessment 300 to determine whether or not to proceed further with candidate 224.

In an alternate embodiment, the responses, probability of success percentile and a summary report explaining whether responses tendered by the candidate are those of a top performer as compared to responses tendered by validation group member 222 could be made available to employer, person or entity requesting the assessment of candidate 224 via hard-copy printouts or electronically via a global networking system.

Updating Performance Data/Refining the AI Engine

Preferably next, in step 328 if updated performance data for validation group member 222 becomes available such data or information may be entered into database 270 and utilized by AI Engine 207 to identify a new subset of custom-weighted performance assessment questions, preferably 80-100 questions (candidate assessment), from the five hundred (500) performance assessment questions administered to the validation group member 222, which differentiate to the best degree between top performers and bottom performers in the target situation or task being performed by validation group member 222. Moreover, AI Engine 207 adjusts the correlation and weighting applied to each existing subset of custom-weighted performance assessment questions, response, and top performer of validation group member's 222 based on the new performance data and/or information, effectively enabling performance assessment questionnaire and method for candidate assessment 300 to evolve and better predict the probability of success percentile of candidate 224 and/or whether candidate 224 is likely to become a top performer in the target situation or task being performed by validation group member 222.

Although the description given above includes specific examples of currently envisioned embodiments of the computer program, method, system, and/or apparatus, these possibilities should not be understood as limiting the scope of the present invention but rather as providing illustrations of some of the embodiments that are now preferred. Several examples of alternate embodiments are also described and various other alternatives, adaptations, and modifications may be made within the scope of the present invention. Merely listing or numbering the steps or blocks of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Thus, it should be noted by those skilled in the art that the within disclosures are exemplary only, and that various other alternatives, adaptations, and modifications may be made within the scope of the present invention. Accordingly, the claims that follow herein and their legal equivalents, rather than the examples given in the specification, should determine the scope of present.

What is claimed is:

1. A computer-based method of performance assessment, comprising the steps of:
a) obtaining an interactive software program capable of presenting a plurality of master questions, each requiring a response;
b) having a plurality of validation group members access said interactive software program, wherein said interactive software program records said responses to said master questions, each member identified as one of a top performer and a bottom performer based on performance data;
c) selecting a subset of questions from said plurality of master questions, wherein responses to said subset of questions differentiate between said top performers and said bottom performers;
d) having at least one candidate, access said interactive software program, wherein said interactive software program records responses of said at least one candidate to said subset of questions; and
e) predicting a performance of said at least one candidate based on said responses of said at least one candidate to said subset of questions.

2. The method of claim 1, wherein said interactive software program generates performance assessment data regarding said at least one candidate based on said responses of said at least one candidate to said subset of questions.

3. The method of claim 1, wherein said interactive software program generates correlation data regarding said plurality validation group members based on said responses to said plurality of master questions.

4. The method of claim 1, wherein said subset of questions comprise content targeted to accurately assess specific qualities within an individual candidate based upon specific traits of said top performers.

5. The method of claim 1, wherein said step of selecting a subset of questions further comprises the step of providing an artificial intelligence engine, wherein said artificial intelligence engine correlates a relationship between each response provided by said validation group members, and weights said response's probability in predicting a top performer.

6. The method of claim 1, wherein said step of predicting a performance of said at least one candidate further comprises the step of providing an artificial intelligence engine, wherein said artificial intelligence engine calculates a probability of said candidate being a top performer.

7. The method of claim 1, further comprising the step of instructing said plurality of said validation group members to respond to said plurality of master questions via a plurality of commands.

8. The method of claim 1, further comprising the step of instructing said candidate to respond to said subset of questions via a plurality of commands.

9. The method of claim 6, further comprising the step of communicating said probability to a user.

10. The method of claim 5, further comprising the step of updating said performance data for said validation group, wherein said artificial intelligence engine re-correlates the relationship between each response provided by said validation group members and re-weights said response's probability in predicting a top performer.

11. The method of claim 1, further comprising the step of preparing a report based on said candidate responses to said questions.

12. A performance assessment software program, comprising:
a plurality of commands for manipulating a computer;
a first plurality of displayable inquiries for eliciting input data from one or more validation group members, wherein said validation group members are identified as one of a top performer and a bottom performer based on performance data;
at least one displayable image;
a second plurality of displayable inquiries for eliciting input data from at least one candidate, wherein said second plurality of displayable inquiries differentiate between said top performers and said bottom performers; and
an artificial intelligence engine, wherein said artificial intelligence engine correlates the relationship between each response provide by said validation group members and weights said response's probability in predicting a top performer.

13. The performance assessment software program of claim 12, wherein said software is accessible via a global network system.

14. The performance assessment software program of claim 12, further comprising a security interface requiring a predetermined input for program access.

15. The performance assessment software program of claim 12, wherein said first plurality of comprises a personality trait question.

16. The performance assessment software program of claim 12, wherein said artificial intelligence engine calculates a probability of said candidate being a top performer.

17. The performance assessment software program of claim 12, wherein said at least one displayable image is comprises a personality trait question.

18. The performance assessment software program of claim 12, wherein said at least one displayable image comprises content targeted to accurately assess specific qualities of a candidate based upon specific performance traits of a top performer.

19. The performance assessment software program of claim 12, wherein said plurality of commands directs the computer to predict a probability of whether said candidate is a top performer based on responses to said second plurality of inquiries.

20. The performance assessment software program of claim 12, wherein said artificial intelligence engine re-correlates the relationship between each response provided by said validation group members and re-weights said response's probability in predicting a top performer based on updated performance data from said validation group.

21. An online performance assessment system, comprising:
interactive graphical interface commands executable by a computer;
a first plurality of displayable inquiries for eliciting input data from at least one validation group member, wherein said at least one validation group member is identified as one of a top performer and a bottom performer based on performance data;
at least one displayable image;
a second plurality of displayable inquiries for eliciting input data from at least one candidate, wherein said second plurality of displayable inquiries differentiate between said top performers and said bottom performers; and
means for correlating the relationship between each input data provided by said at least one validation group member and weighting said input data probability in predicting a top performer.

22. The system as claimed in claim 21, wherein said first plurality of displayable inquiries is accessible via a global network system.

23. The system as claimed in claim 21, further comprising a security interface requiring a predetermined input for program access.

24. The system as claimed in claim 21, wherein said first plurality of inquiries comprises a personality trait question.

25. The system as claimed in claim 21, wherein said means calculates a probability of said candidate being a top performer.

26. The system as claimed in claim 21, wherein said at least one displayable image comprises a personality trait question.

27. The system as claimed in claim 21, wherein said at least one displayable image comprises content targeted to accurately assess specific qualities of a candidate based upon specific performance traits of a top performer.

28. The system as claimed in claim 21, wherein said commands direct the computer to predict a probability of said candidate being a top performer based on responses to said second plurality of inquiries.

29. The system as claimed in claim 21, wherein said means re-correlates the relationship between each response provided by said validation group members and re-weights said response's probability in predicting a top performer based on updated performance data from said candidate.

30. The system as claimed in claim 21, further comprising means for preparing a report based on said first and second plurality of displayable inquiries.
